(19) United States
(12) Patent Application Publication
(10) Pub. No.: US 2024/0229247 A9
(43) Pub. Date: Jul. 11, 2024

(54) ACID-INDUCED STEEL CORROSION INHIBITOR BASED ON ROTTEN EGGS

(71) Applicant: KING FAISAL UNIVERSITY, Al-Ahsa (SA)

(72) Inventors: HANY MOHAMED ABD EL-LATEEF, AL-AHSA (SA); MOHAMED GOUDA MAHMOUD, AL-AHSA (SA); MAI MOSTAFA KHALAF ALI, AL-AHSA (SA); REDA MOHAMED EL-SHISHTAWY, AL-AHSA (SA)

(21) Appl. No.: 17/971,078

(22) Filed: Oct. 21, 2022

(51) Int. Cl. C23F 11/16; C23F 11/18

(52) U.S. Cl. CPC C23F 11/16; C23F 11/18; B82Y 30/00

(57) ABSTRACT

The acid-induced steel corrosion inhibitor based on rotten eggs provides a corrosion inhibitor that is biodegradable, has low toxicity, is water-soluble, easily produced, and is low-cost through the use of waste material, namely, white eggs (EWs). The corrosion inhibitor is added to a corrosive medium in an aqueous medium to protect the metal surfaces and steel interfaces on metal production equipment, such as pumps, tubing, and casing. The corrosion inhibitor based on rotten white eggs is loaded with metal nanoparticles (EWMNPs). The eco-friendly less destructive corrosion inhibitors based on metal nanoparticles synthesized with rotten white eggs are efficient to protect steel from corrosion, while still dissolving in oil streams produced without or with salt water and being soluble in acidic mediums containing chlorides. The corrosion inhibitors have low toxicity to marine life when discharged into the ocean, thereby protecting the marine life, particularly near the system's drain.

### BACKGROUND

### 1. Field

The disclosure of the present patent application relates to corrosion inhibitors, and particularly to an acid-induced steel corrosion inhibitor based on rotten eggs.

### 2. Description of the Related Art

Many petroleum manufacturing constructions produce brine, hydrocarbons, carbon dioxide (CO₂), and/or hydrogen sulfide (H₂S), which are very harsh on metal production equipment, such as pumps, tubing, and casing. A common approach to decreasing corrosion in the equipment is to add an acid-induced steel corrosion inhibitor to the aggressive solution to preserve the metal surfaces. Some corrosion inhibitors are chemical formulations and compounds that, when added in minor amounts to the corrosive solution, inhibit corrosion by carrying about modifications in the metal surface condition. These commercially available inhibitors are highly toxic to the marine environment. Governments and operating companies ae becoming more concerned about this environmental impact and the toxicity of petroleum companies' inhibitors, particularly in offshore systems. In offshore systems, eco-friendly and high protection capacity inhibitors are even more important than in land-based systems. In order to protect the marine environment, corrosion inhibitors must be nontoxic to plants, fish, and other organisms.

Thus, an acid-induced steel corrosion inhibitor based on rotten eggs is desired.

### SUMMARY

The acid-induced steel corrosion inhibitor based on rotten eggs provides a corrosion inhibitor that is biodegradable, has low toxicity, is water-soluble, easily produced, and is low-cost through the use of waste material, namely rotten white eggs (EWs). The corrosion inhibitor is added to a corrosive medium in an aqueous medium to protect the metal surfaces and steel interfaces on metal production equipment, such as pumps, tubing, and casing. The corrosion inhibitor based on rotten eggs is loaded with metal nanoparticles (EWMNPs) of silver (Ag), nickel, (Ni), copper (Cu), iron (Fe), and/or cerium (IV) oxide, (CeO₂). The Ag, Ni, Cu, Fe, and CeO₂ nanoparticles enhance the anticorrosive and barrier features of the EWs. The eco-friendly, less destructive corrosion inhibitors based on metal nanoparticles synthesized with rotten white eggs are efficient to protect steel from corrosion, while still dissolving in oil streams produced without or with salt water and being soluble in acidic mediums containing chlorides. The corrosion inhibitors have low toxicity to marine life when discharged into the ocean, thereby protecting marine life, particularly near the system's drain. The acid-induced steel corrosion inhibitors are particularly useful for petroleum companies to protect their steel pipelines from acid-induced corrosion.

These and other features of the present subject matter will become readily apparent upon further review of the following specification.

### BRIEF DESCRIPTION OF THE DRAWINGS

FIG. 1A is a transmission electron microscope (TEM) image of white egg/silver nanoparticles at 50,000× magnification.

FIG. 1B is a TEM image of white egg/cerium (IV) oxide nanoparticles at 50,000× magnification.

FIG. 1C is a TEM image of white egg/zinc nanoparticles at 50.000× magnification.

FIG. 1D is a TEM image of white egg/copper nanoparticles at 50.000× magnification.

FIG. 2A is a scanning electron microscope (SEM) image of pristine X60 steel.

FIG. 2B is an SEM image of X60 steel after being immersed in an acidizing oil well medium for 24 hours.

FIG. 2C is an SEM image of X60 steel after being immersed in an acidizing oil well medium containing 200 mg/L of white egg/cerium (IV) oxide nanoparticles for 24 hours.

Similar reference characters denote corresponding features consistently throughout the attached drawings.

### DETAILED DESCRIPTION OF THE PREFERRED EMBODIMENTS

The acid-induced steel corrosion inhibitor based on rotten white eggs (EW) incorporating metal nanoparticles (EWMNPs) includes various embodiments produced using a simple method, as described below.

In a first embodiment, to form the EWMNPs, various quantities of a metal nitrate salt aqueous solution (8.5 mg/mL) of Ag, Ni, Cu, Fe, and/or CeO₂ are added to 24 mL of water, and after 5 minutes of mixing, pure EW is added to the metal salt solution. This mixture is kept under vigorous stirring for 5 minutes, followed by the drop-wise addition of a specific amount of sodium borohydride (NaBH₄) solution (1.0 mg/mL) as a reducing agent. The reaction is kept stirring for 10.0 minutes to prepare the EWMNPs suspended in colloidal solution. The solution may be kept refrigerated for storage.

The corrosion protection performance of the prepared corrosion inhibitors was tested for X60 steel alloys in acidizing oil well medium. The corrosion inhibition capacity was determined by linear polarization resistance corrosion rate, open circuit potential (Ep) time, electrochemical impedance spectroscopy, and potentiodynamic polarization tools. The corrosion inhibitors exhibited high protection capacity for X60 steel alloys ranging from 93.5% to 98.4% in the presence of 200 ppm (200 mg/L) of inhibitor. The surface morphology was determined using field emission scanning electron microscopy with energy dispersive X-ray spectroscopy (FESEM/EDX) measurements, which established the high efficacy of the fabricated composites on the protected X60 steel alloys, indicating the adsorption of the inhibitor molecules at the interface of steel/solution, and therefore playing a significant role in the corrosion inhibition efficiency.

The obtained linear polarization resistance corrosion rate findings indicated that about 97.2% protection efficiency of steel corrosion was detected after 20 hrs. exposure to 200 ppm EWM/CeO₂ NPs. The EWM/CeO₂NPs composite is adsorbed at the steel/corrosive medium interface by both physisorption and chemisorption approaches. Other obtained linear polarization resistance corrosion rate findings included: EWM/CeO₂ NPs (98.4%); EWM/Fe NPs (97.1%); EWM/Ni NPs (96.5%); EWM/Cu NPs (94.2.1%); and EWM/Ag NPs (93.5%); all in the presence of 200 mg/L of inhibitor. The results indicate that all of the above EWMNPs are suitable eco-friendly inhibitors for steel corrosion in pickling acidic medium when injected into the production line of the treated system. The inhibitors coat the metallic surface, thereby inhibiting subsequent surface corrosion by the aggressive ions in the flowing solution.

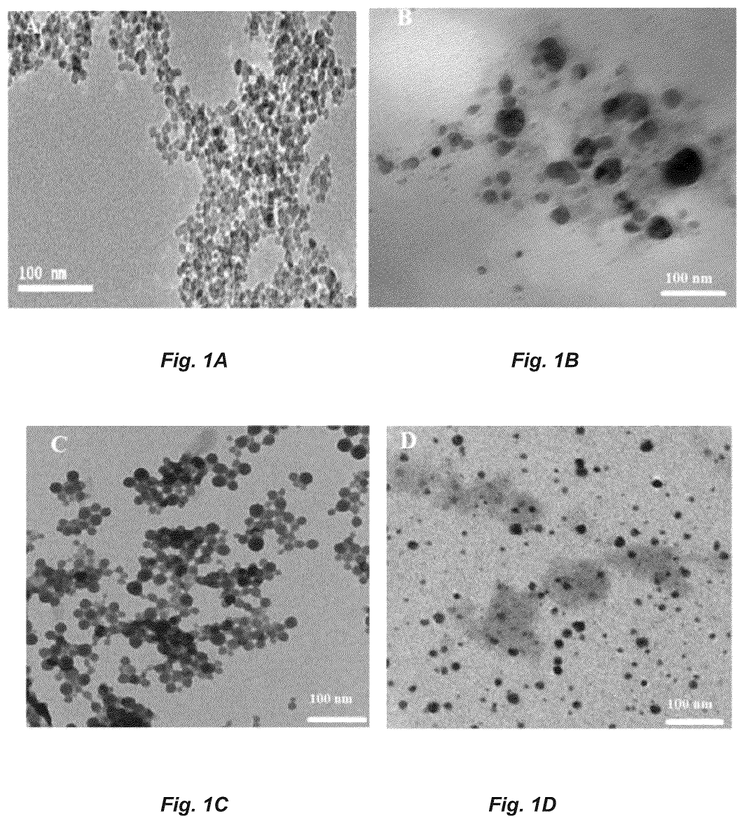

FIGS. 1A-1D show the morphology of the nanoparticles as seen by TEM at 50,000× magnification. The nanoparticles are almost spherical, with somewhat homogeneous particle size and equal dispersion. The white egg/metal NPs have a black core surrounded by a brilliant membrane, indicating the presence of a separate layer. The white egg/Ag NPs have an average size of 20 nm, while the white egg/CeO₂ NPs have an average size of 108 nm. The white egg/Zn NPs have an average size of 42 nm, while the white egg/CuNPs have an average size of 33 nm. The TEM images also indicate that the nanoparticles have restricted distribution and moderate aggregation.

As previously noted, the corrosion protection performance of the prepared materials was tested for X60 steel alloys in an acidizing oil well medium. The composites exhibited high protection capacity for X60 steel alloys ranging from 93.5 to 98.4 in the presence of 200 mg/L of inhibitor (in the form of a colloidal suspension of nanoparticles). The surface morphology measurements using field emission scanning electron microscope/energy dispersive X-ray spectroscopy (FESEM/EDX) indicate the high efficacy of the composites in the protection of X60 steel alloys.

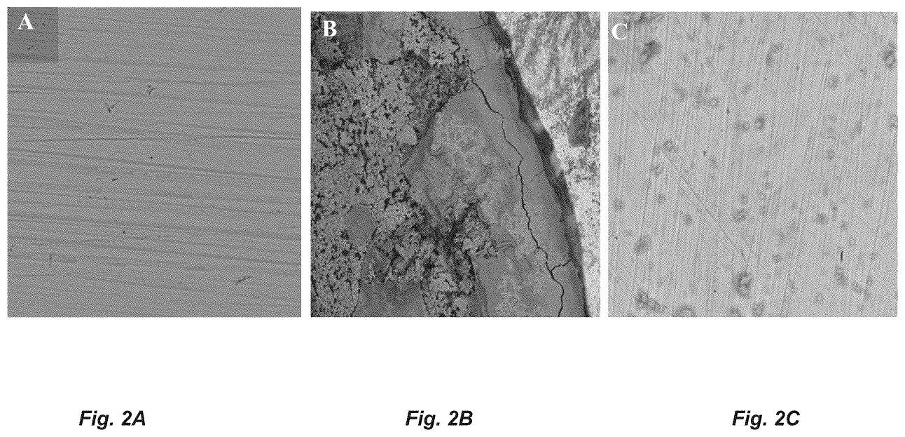

FIG. 2A shows a scanning electron microscope (SEM) image of pristine X60 steel, while FIG. 2B shows an SEM image of X60 steel after being immersed in an acidizing oil well medium for 24 hours, and FIG. 2C is an SEM image of X60 steel after being immersed in an acidizing oil well medium containing 200 mg/L of white egg/cerium (IV) oxide nanoparticles for 24 hours. As can be seen from FIG. 2B, the surface of steel without corrosion inhibitors has numerous pits, which indicates the severity of the steel corrosion caused by Cl⁻. As can be seen in FIG. 2C, however, the steel protected by the corrosion inhibitor has a smoother surface, which suggests that the EW/CeO₂ inhibitor has a tight adsorption on the surface, thereby efficiently inhibiting Cl⁻ from corroding the steel surface.

It is to be understood that the acid-induced steel corrosion inhibitor based on rotten eggs is not limited to the specific embodiments described above but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1: An acid-induced steel corrosion inhibitor, comprising an aqueous solution of:
rotten egg whites; and
metal nanoparticles, the metal nanoparticles being selected from the group consisting of silver nanoparticles, nickel nanoparticles, copper nanoparticles, iron nanoparticles and cerium oxide nanoparticles.

2: The acid-induced steel corrosion inhibitor of claim 1, wherein the metal nanoparticles are silver nanoparticles.

3: The acid-induced steel corrosion inhibitor of claim 1,
wherein the metal nanoparticles are nickel nanoparticles.

4: The acid-induced steel corrosion inhibitor of claim 1,
wherein the metal nanoparticles are copper nanoparticles.

5: The acid-induced steel corrosion inhibitor of claim 1,
wherein the metal nanoparticles are iron nanoparticles.

6: The acid-induced steel corrosion inhibitor of claim 1, wherein the metal nanoparticles are cerium oxide nanoparticles.

7. (canceled)

8: A method of forming an acid-induced steel corrosion inhibitor, comprising the steps of:
adding a metal nitrate salt aqueous solution to water to form a metal salt solution;
mixing the metal salt solution for a first period of time;
adding pure rotten egg whites to the metal salt solution to form a first mixture;
stirring the first mixture for a second period of time;
adding sodium borohydride solution to the first mixture to form a second mixture; and
stirring the second mixture for a third period thereby preparing the acid-induced steel corrosion inhibitor.

9: The method of forming an acid-induced steel corrosion inhibitor of claim 8, wherein the first period of time is five minutes.

10: The method of forming an acid-induced steel corrosion inhibitor of claim 8, wherein the second period of time is five minutes.

11: The method of forming an acid-induced steel corrosion inhibitor of claim 10, wherein the step of stirring the first mixture for five minutes comprises vigorously stirring the first mixture for five minutes.

12: The method of forming an acid-induced steel corrosion inhibitor of claim 8, wherein the step of adding the sodium borohydride solution to the first mixture to form the second mixture comprises drop-wise addition of the sodium borohydride solution to the first mixture.

13: The method of forming an acid-induced steel corrosion inhibitor of claim 8, wherein the third period of time is ten minutes.

14: A method of forming an acid-induced steel corrosion inhibitor, comprising the steps of:
adding a metal nitrate salt aqueous solution to water to form a metal salt solution;
mixing the metal salt solution for five minutes;
adding pure rotten white eggs to the metal salt solution to form a first mixture;
stirring the first mixture for five minutes;
adding a sodium borohydride solution dropwise to the first mixture to form a second mixture; and
stirring the second mixture for ten minutes.
